(19) United States
(12) Patent Application Publication
(10) Pub. No.: US 2012/0078726 A1
(43) Pub. Date: Mar. 29, 2012

(54) SYSTEM AND METHOD FOR PROVIDING ENHANCED LOCAL ACCESS TO COMMERCIAL ESTABLISHMENTS AND LOCAL SOCIAL NETWORKING

(76) Inventors: Jason Michael Black, Boca Raton, FL (US); Gary H. Elzweig, Plantation, FL (US); Melissa Sabarese, Wesley Chapel, FL (US)

(21) Appl. No.: 13/088,909

(22) Filed: Apr. 18, 2011

Related U.S. Application Data
(60) Provisional application No. 61/387,945, filed on Sep. 29, 2010.

(51) Int. Cl. G06Q 30/00; G06F 15/16

(52) U.S. Cl. 705/14.66; 705/14.49; 709/204

(57) ABSTRACT

A system and method for mobile interactive communication on a local social networking platform is presented. In particular, the invention comprises a plurality of mobile user interfaces disposed in a communicative relation with at least one local network, such as WLAN, LAN, WIFI hotspot, etc. Each of the mobile devices or interfaces are structured to execute, access or run a social networking application which, in at least one embodiment, is capable of automatically receiving and displaying promotional media communicated by or on behalf of a nearby commercial establishment, wherein the commercial establishment is located within a user-selected promotional range. A number of mobile devices connected to either common or different local networks may also communicate to one another (via chat, voice or video chat, send images, data, etc.) so long as the mobile devices are disposed within a user-selected communication range.

### CLAIM OF PRIORITY

The present application is based on and a claim to priority is made under 35 U.S.C. Section 119(e) to provisional patent application currently pending in the U.S. Patent and Trademark Office, having Ser. No. 61/387,945 and a filing date of Sep. 29, 2010, the entirety of which is incorporated herein by reference.

### BACKGROUND

1. Field of the Invention

The present invention is generally directed to a system and method for mobile interactive communication via one or more local social networks. In particular, users of the local social network may communicate with one another via a mobile user device or interface and receive promotional media, such as coupons, advertisements, etc., from local commercial establishments. More particularly, the present invention comprises a system and method, including one or more mobile devices, servers, networking devices, and the various circuitry, hardware and software applications structured to implement the embodiments described herein.

2. Description of the Related Art

Younger and older generations alike have come to rely heavily on portable and/or mobile electronic devices and by extension, a greater dependency (and demand) for services, both social and commercial, on their portable electronic devices. Increasingly, many users of social network systems and commercial promotion systems which are accessible via portable electronic devices desire a more location-based system by which to connect to each other, without reliance on a cost-prohibitive data plan service.

While many resources and systems exist for social networking and commercial promotion using portable electronic devices, there is no present system that capitalizes on the omnipresence of free public unsecured wireless local area networks (“WLAN”) as a medium to socialize or to reach potential consumers.

Additionally, users of portable electronic devices and the associated networking and commercial systems desire a system that provides the flexibility to access and view data from other users and commercial establishments in a geographically-based format, as opposed to the existing list-based systems. This would help users locate other users and commercial establishments more easily.

### SUMMARY

The present invention is generally directed to a system and method for providing enhanced social and commercial networking and/or for mobile interactive communication on a local social networking platform. In particular, the various embodiments presented herein are directed to providing enhanced location-based social and commercial networking through an integrated social networking mobile application accessed by or executed on a portable or mobile user electronic device.

For example, the portable or mobile user electronic device may include an integrated or accessible social networking application operative to interface or otherwise communicate with one or more computer communication networks, including but not limited to WLANs, WIFI hotspots, PANs, LANs, and/or one or more various networks implemented by or based upon the IEEE 802.11 standard or other similar standards structured to facilitate the practice of the present invention in the intended manner. For example, in at least one embodiment, the social networking application, via free public unsecured WLANs, or other communication network(s), can provide information on the presence and location of other users detected in the same network or networks located within a user-selected communication range, and enable users to communicate and exchange data directly with those users over the communication network(s). As another example, the application can connect to one or more free public unsecured or secured WLANs, or other network(s), available from one or more commercial establishments to receive information and services available from the hosting commercial establishment(s). As an example, the application can receive offers of assistance from or send requests for assistance to a commercial establishment to which it is connected via the communication network, such as the corresponding WLAN or WIFI hotspot.

In some embodiments, the social networking application can connect users to other users over a greater or smaller geographical radius from the user, depending on the user's preferences at the time. For example, via the mobile user device or interface and through the application, a user can select to view only users connected to a particular or common network, or a user can select to view other users located within a user-selected radius, which, in at least one embodiment may be determined by mileage.

In some embodiments, the social networking application provides functions to attract or entice users within the reach of the particular commercial establishment's WLAN or WIFI hotspot to patronize their establishment. For example, through the application, a user can be enticed through the use of (e.g., a notification that utilizes an internet protocol (“IP”) connection to forward notifications from the servers of third party applications to an electronic device) notifications indicating daily specials, coupons, events, and menus.

In at least one further embodiment of the present invention, the social networking application can provide a user with sales or other customer assistance services. For example, the user may initiate a communication with the commercial establishment for assistance with an order, to make a reservation, or to place an order in advance.

In yet another embodiment, the present invention is structured to enhance the user's social networking experience. For instance, the social networking application of at least one embodiment is structured to access or otherwise communicate with a remote social networking management system comprising a database or other memory or storage device of various social media including user profiles comprising the users' preferences, tastes, list of friends, friends' preferences and tastes, etc. Based on that database and information contained therein, the social networking application of at least one embodiment is structured to match or link one or more users and the corresponding user profile(s) with other users and user profiles comprising similar interests, preferences, tastes, etc., and indicate to each user that another user with similar interests is in the vicinity. The integrated application may then give the users the opportunity to initiate communication with these similar users.

In some embodiments, the social networking application can provide users the opportunity to communicate with other users via real time messaging (“chat”), video-chat, or voice-chat, without the need to disclose a personal phone number. For example, the application informs a user that another user with similar musical or other tastes is nearby, and the user can initiate a conversation with the other user. The receiving user via the corresponding mobile user device and social networking application will receive a push notification and will have the opportunity to accept or decline to chat with the initiating user.

As will be described in greater detail hereinafter, the social networking application of at least one embodiment is structured to provide users with the ability to exchange data and/or media with other users. For instance, a user may see something in the vicinity, take a photograph with the user's portable or mobile electronic device, and send it to one or more selected users, or to all users detected or otherwise located in the same communication network. As another example, users may also send to other users' ringtones, contacts, video files, or audio files.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of the system for mobile interactive communication via one or more local social networks as disclosed in accordance with at least one embodiment of the present invention.

FIG. 2 is another schematic representation of the system as disclosed in accordance with at least one embodiment of the present invention.

FIG. 3 is a schematic view of a mobile user electronic device suitable for providing enhanced local access to commercial establishments and social networking in accordance with the present invention.

FIGS. 4A through 4D are screenshots illustrating at least one embodiment of the social networking application of the present invention.

FIGS. 5A though 5F are screenshots illustrating yet another embodiment of the social networking application as disclosed herein.

FIGS. 6A and 6B are screenshots of at least one exemplary embodiment of the social group application as disclosed herein.

FIG. 7 is a flow diagram illustrating various steps implemented by the method for mobile interactive communication as disclosed in accordance with at least one embodiment of the present invention.

FIG. 8 is a high level flow chart of the method for mobile interactive communication as described herein.

Like reference numerals refer to like parts throughout the several views of the drawings.

### DETAILED DESCRIPTION

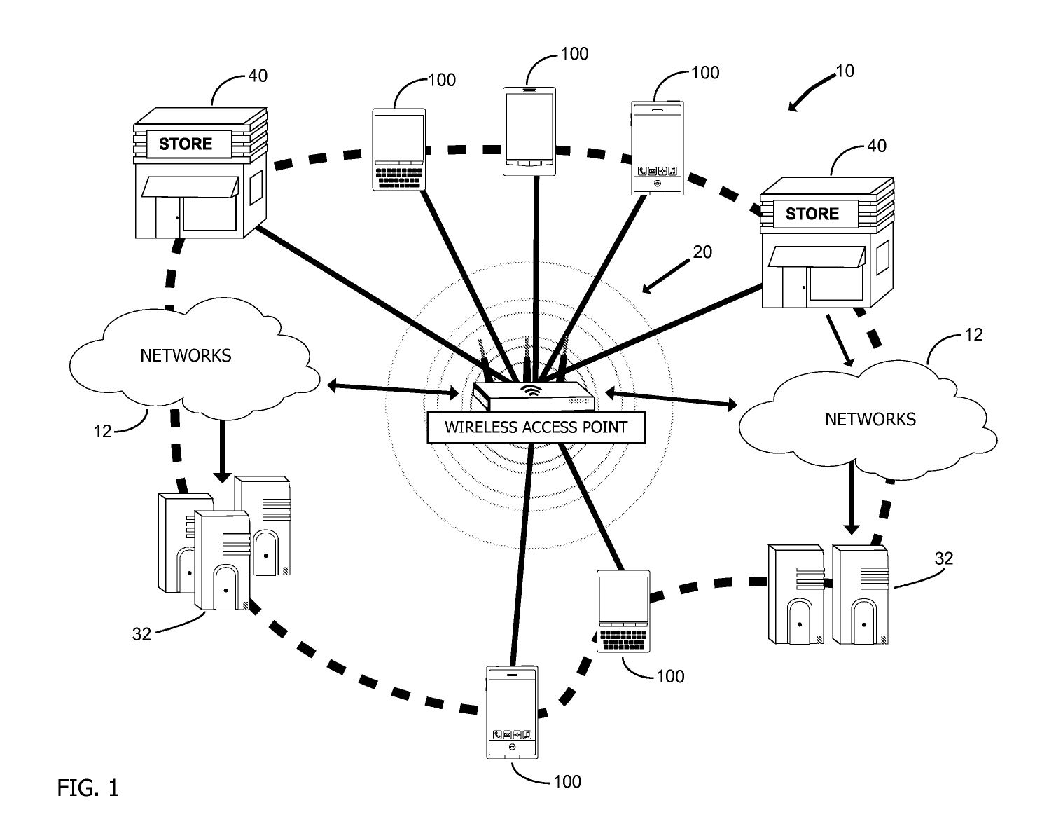

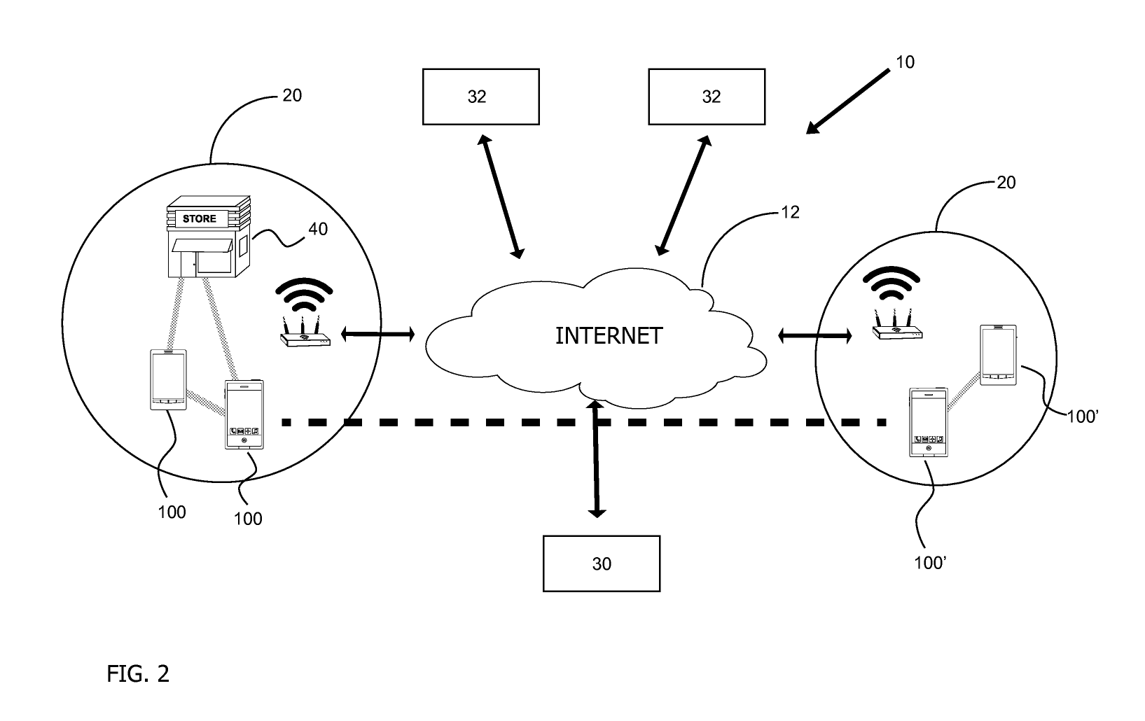

As shown in the accompanying drawings, and with particular reference to FIGS. 1 and 2, the present invention is generally directed to a system 10 and method for mobile interactive communication on a local social networking platform. In particular, the various embodiments of the present invention comprise one, but more practically, a plurality of portable/mobile user devices and/or interfaces, generally represented as 100. Each of the portable/mobile user devices 100 are suitable for providing enhanced local access to commercial establishments and social networking in accordance with some embodiments of the present invention as disclosed herein.

In particular, the mobile user devices 100 are structured to communicate with one or more local communication networks 20, including, but certainly not limited to a WLAN, WAN, LAN, WIFI hotspot, Intranet, etc. Accordingly, the electronic and/or mobile user devices 100 can include any suitable type of electronic device, including a digital media player (such as an iPod® made available by Apple Inc. of Cupertino, Calif.), a hand-held multi-media device (such as an iPhone®, iPad®, etc., made available by Apple Inc. of Cupertino, Calif., a Blackberry® made available by Research in Motion of Waterloo, Ontario, a mobile device utilizing Android™, Windows Mobile® or other mobile-based operating systems, etc.), an e-mail device, a personal data assistant (“PDA”), a cellular or mobile telephone, a handheld gaming device, a digital camera, etc. Furthermore, the mobile user devices 100 of at least one embodiment can also include a larger portable electronic device, such as a laptop computer or tablet computer, and a substantially fixed electronic device, such as a desktop computer.

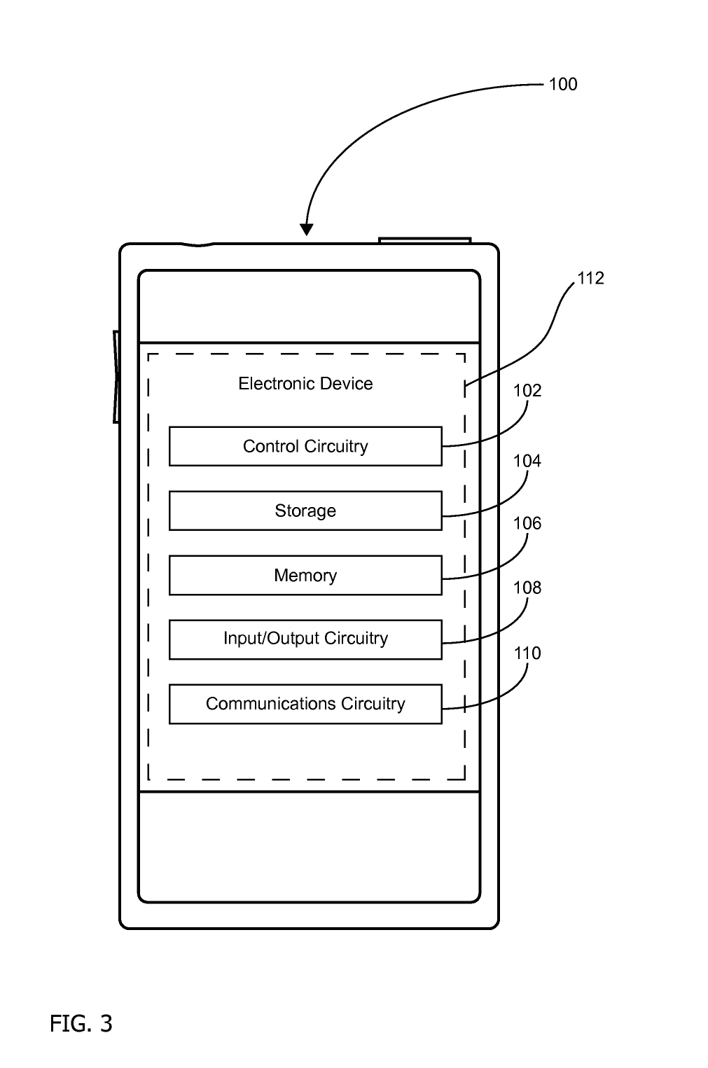

Therefore, referring now to the schematic representation of FIG. 3, the mobile user or electronic device 100 comprises control circuitry 102, storage 104, memory 106, input/output (“I/O”) circuitry 108, communications circuitry 110, and a display 112. In some embodiments, mobile user device 100 can include other components not included in those shown in FIG. 3 (e.g., power supply such as a battery, a global positioning system, a rear facing camera, a forward facing camera, a microphone, a speaker, etc). For the sake of simplicity, only one of each aforementioned component is shown in FIG. 3.

In particular, the control circuitry 102 can include any processing circuitry or processor operative to control the operations and performance of mobile user device 100, as described in greater detail herein. For example, control circuitry 102 can be used to run, access, and/or execute various applications including, but not limited to, operating system applications, firmware applications, media playback applications, media editing applications, or any other application, including the social networking application of the present invention. In some embodiments, control circuitry 102 can drive a display and process inputs received from a user interface.

In addition, the storage device 104 can include, for example, one or more storage mediums including a hard-drive, solid state drive, flash memory, permanent memory such as ROM, any other suitable type of storage component, or any combination thereof. Storage device 104 can store, for example, media data (e.g., music and video files), application data (e.g., for implementing functions on electronic device 100), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable mobile user device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM, and/or one or more different types of memory used for temporarily storing data. In some embodiments, memory 106 can also be used for storing data used to operate, access, execute or run one or more electronic device applications, or any other type of data that can be stored in storage 104. In some embodiments, memory 106 and storage device 104 can be combined as a single storage medium.

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 3 as a single component of electronic device 100, several instances of I/O circuitry 108 can be included in electronic device 100.

Moreover, the mobile user device 100 of the various embodiments of the present invention can include any suitable interface or component for allowing a user to provide inputs to I/O circuitry 108. For example, user device 100 can include any suitable input mechanism, such as for example, a button, keypad, dial, a click wheel, or a touch screen. In some embodiments, the user device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into the user device 100, or an audio component that is remotely coupled to electronic device 100 (e.g., a headset, headphones or ear buds that can be coupled to communications device with a wire or wirelessly). In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (CODEC) to convert digital media data into analog signals. For example, the display circuitry (or other appropriate circuitry within electronic device 100) can include video CODECs, audio CODECs, or any other suitable type of CODEC. The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102.

The communications circuitry 110 can include any suitable communications circuitry operative to connect to a communications network and to transmit communications (e.g., voice or data) from user device 100 to other devices within the communications network or within a user-selected communication range, as discussed below. Communications circuitry 110 can be operative to interface with the communications network using any suitable communications protocol such as, for example, Wi-Fi (e.g., a 802.11 protocol), Bluetooth, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In some embodiments, the communications circuitry 110 can be operative to create a communications network using any suitable communications protocol. For example, communications circuitry 110 can create a short-range communications network using a short-range communications protocol to connect to other devices. For example, the communications circuitry 110 can be operative to create a local communications network using the Bluetooth protocol to couple an electronic device 100 with a Bluetooth headset.

The user device 100 can further include one more instances of communications circuitry 110 for simultaneously performing several communications operations using different communications networks, although only one is shown in FIG. 3 to avoid overcomplicating the drawing. For example, user device 100 can include a first instance of communications circuitry 110 for communicating over a cellular network, and a second instance of communications circuitry 110 for communicating over WLAN or using Bluetooth. In some embodiments, the same instance of communications circuitry 110 can be operative to provide for communications over several communications networks.

In some embodiments, the user device 100 can be coupled with a host device or remote social networking management system 30 (FIG. 2) for data transfers, synching the user device 100, software or firmware updates, providing performance information to a remote source (e.g., providing riding characteristics to a remote server 30) or performing any other suitable operation that can require electronic device 100 to be coupled to a host device. Several electronic devices 100 can be coupled to a single host device using the host device as a server. Alternatively or additionally, the electronic device 100 can be coupled to several host devices (e.g., for each of the plurality of the host devices to serve as a backup for data stored in electronic device 100).

In at least one embodiment of the present invention, the user devices 100 include, access, run and/or execute a social networking application 200 operative to interface with other users or other user devices 100 utilizing, accessing, executing or running the same or similar application 200, including commercial establishments as well as other individuals. For instance, the social networking application 200 disclosed herein may be downloaded or installed on the user device 100, such that at least a portion of execution of the application 200 occurs locally on the device 100 itself. In other embodiments, it is contemplated that the user device 100 may access or execute the application 200 remotely, for instance, via a communication network, wherein the application resides on one or more remote servers 30 or other types of computers.

In particular, the social networking application 200 of the present invention, when executed or accessed by one or more user devices 100, can be used to provide real-time, updates, and live access to the different services and products of a commercial establishment 40. Specifically, the social networking application 200 of at least one embodiment of the present invention is structured to automatically receive and display promotional media associated with the commercial establishment 40. For example, the application 200 of the present invention is structured to allow the commercial establishment 40 hosting the free public WLAN, WIFI hotspot, or other communication network 20 to which the user device 100 is connected (the “host commercial establishment”), to attract customers by sending promotional media in the form or coupons, advertisements, select deals, etc., directly to a user device 100. In addition, the application 200 of the present invention can provide a store locator to permit a user to easily locate the host commercial establishment 40, or otherwise can attract a user to the host commercial establishment 40.

As another example, the social networking application 200 of the present invention can provide a user with enhanced information regarding the products and services of a host commercial establishment 40 by allowing a user to take a photograph of an item about which it seeks additional information and send it to the host commercial establishment 40 with a request for additional, and perhaps specific, information, and the like. As yet another example, the social networking application can provide a user with post-purchase opportunities (e.g., returns, exchanges, additional offers). In this manner, through the social networking application 200 disclosed in accordance with the present invention, a host commercial establishment 40 can maintain a constant connection between themselves and the user or user device(s) 100. This can result in changing a user's entertainment, shopping, or dining experience from a series of isolated incidents and a sometimes disorganized process to an experience that is more efficient, smooth and pleasurable for the user.

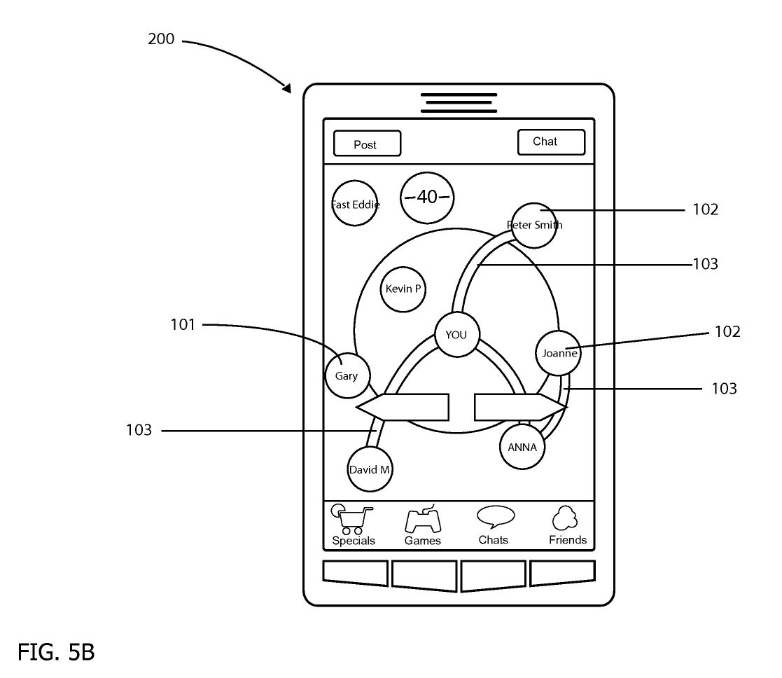

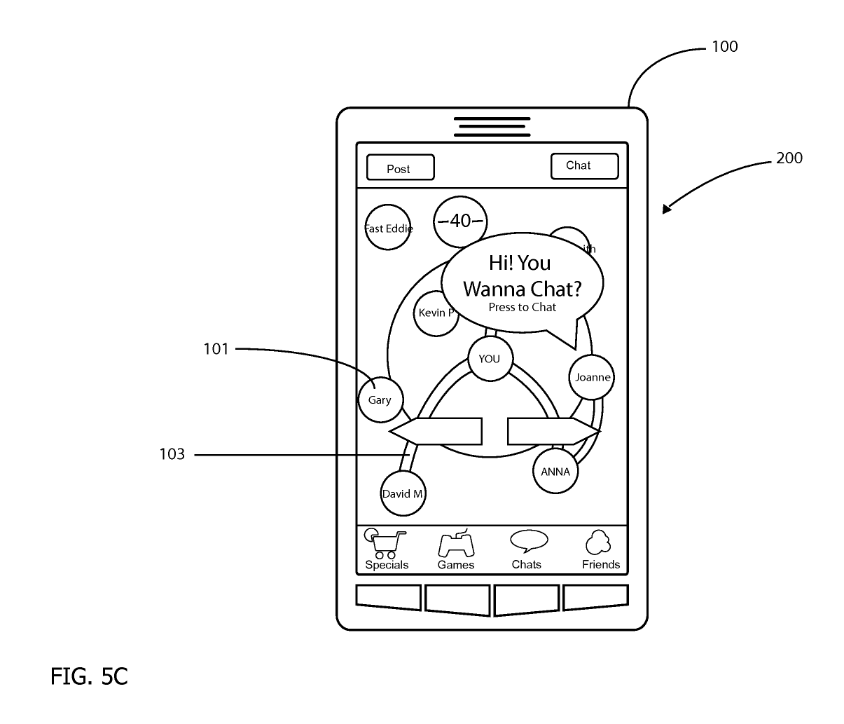

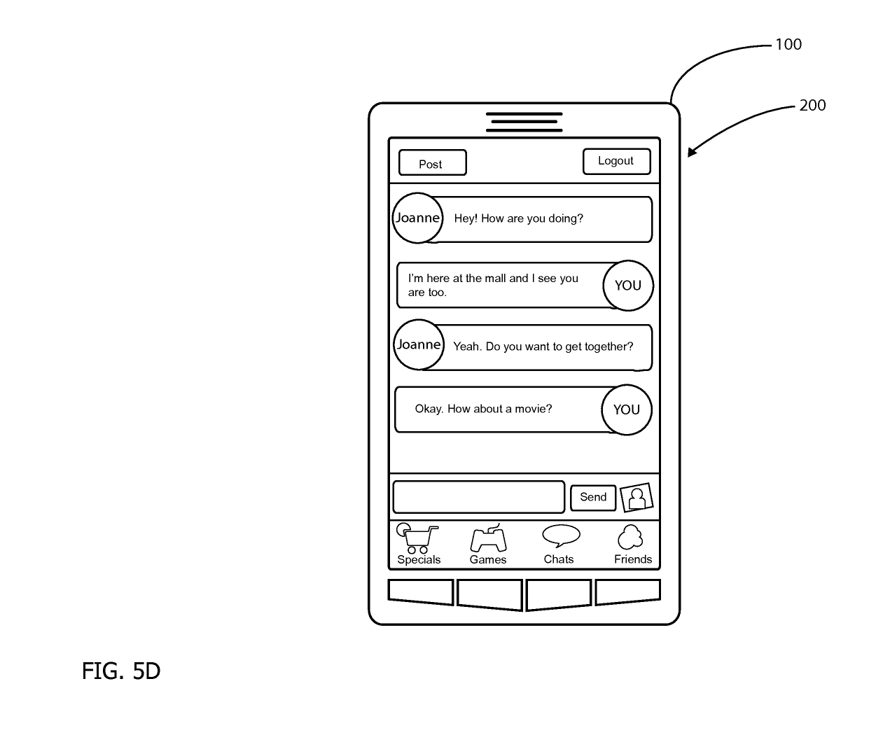

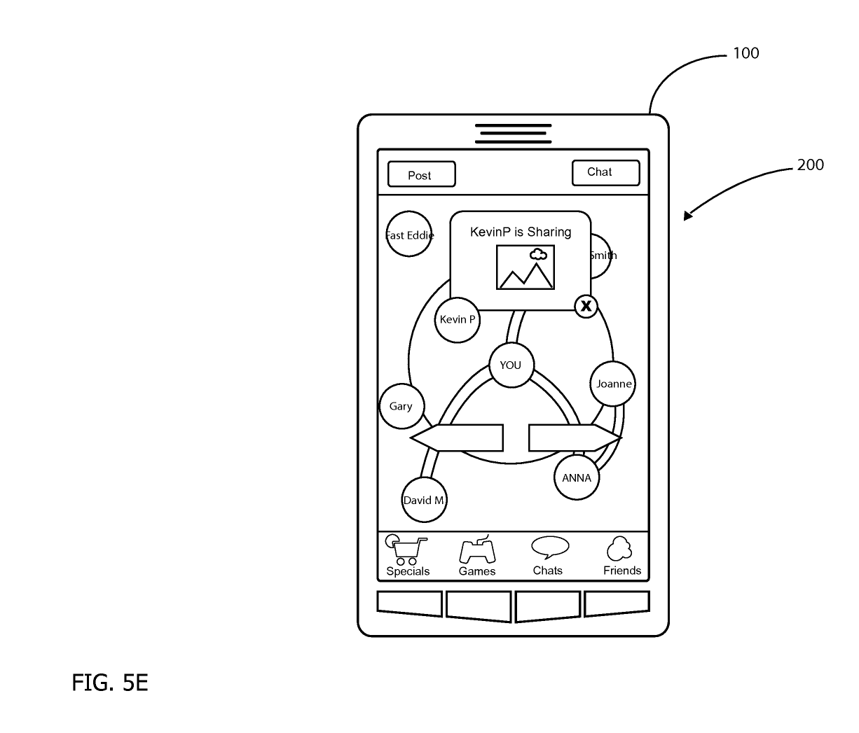

For instance, to interface with the host commercial establishment 40, the social networking application 200 can use any suitable approach. In some embodiments, the user device 100 can securely connect to one or more servers 30, 32 or other commercial communication devices associated with the host commercial establishment 40 (e.g., through communication circuitry 110). For example, the social networking application 200 can connect to servers 32 which are made available by or from one or more of the commercial establishments 40 to automatically receive information and/or promotional media 34 (FIG. 5F) regarding their products and services. In particular, the establishment servers 32 may be disposed locally at the commercial establishment's place of business or remotely and accessed via the Internet or other networks. In other embodiments, the commercial establishment 40 may comprise one or more dedicated or shared commercial communication devices (including a wireless access point, router, or dedicated promotional and/or proprietary stand-alone device) situated on the premises and structured to connect to the network 20 and/or otherwise communicate promotional media to the mobile user device 100 as described herein. The server(s) 32 and/or other commercial communication devices may be updated regularly with new promotional media such that the user devices 100 receive up-to-date information accordingly. In yet another embodiment, however, the remote social networking management system 30 is structured to communicate the promotional media 34 to appropriate mobile devices 100 or social networking applications 200, for example, depending on the current location of the mobile device 100 and/or the user's profile information (such as preferences, gender, age, interests, etc.)

In particular, via an advertiser control panel or dashboard, an advertiser, which may be associated with a particular commercial establishment 40 (or the owner, manager, marketing team, etc. thereof) may upload, modify, sign up for, and/or otherwise manage the promotional media 34 that is to be communicated to the mobile device 100 and/or social networking application 200 in accordance with the various embodiments of the present invention. Specifically, the dashboard or control panel may be hosted by the social networking management system 30 or otherwise be made available by virtue of access to the Internet or web page via a web browser, mobile application, etc. More in particular, the advertiser or commercial establishment 40 may log into the control panel or dashboard and sign up for, select or manage an advertising plan for use with the social networking application 200 of the present invention.

For exemplary purposes only, the advertisement plan(s) may comprise various options and features, including, but not limited to, a range of broadcasting the advertisement(s) (e.g., whether the advertisement will be broadcasted within the advertiser's WIFI hotspot only, within multiple overlapping or disconnected WIFI hotspots, or over a radius for example up to 200 miles), the type of advertisement(s) (e.g., text only, text and image, video, etc.), the frequency of broadcasting the advertisement(s), the type of delivery (e.g., push notification, text message, email, pop-up, within the social networking application 200 only, or any combination), etc. The advertiser may log into the control panel or dashboard and manage these and other options, upload or revise images, upload or revise advertisements, upload or revise campaigns, retrieve analytical performance reports, etc.

In addition, the remote social networking management system 30 of at least one embodiment is structured to communicate advertisements or promotional media 34 to particular targeted users. For example, via the control panel or dashboard, the advertiser may describe or select a target group or a plurality of target attributes of user's in which the advertiser desires to target. For instance, the advertiser may describe or select a particular target age group or range, gender, race, user preference, user hobbies, user interests, etc. Based upon that selection, the system of at least one embodiment of the present invention is structured to target the advertisements to the selected targeted groups or preferences.

Accordingly, in at least one embodiment, an advertisement plan in which an advertiser can sign up for may include a per-user fee in which the advertiser is charged a fee for each targeted user the advertisement is communicated to. Other advertisement plans may include a different fee for the type of advertisement (e.g. text only, text with graphic, video message, etc.), broadcasting ranges, per user or per message fee, frequency, (e.g., ten advertisements per day), duration (e.g., the advertisement will run for one month) etc. For exemplary purposes only, the advertiser may be required to pay a one-time set up fee followed by subsequent monthly subscription fees depending on the plan or selected options as described above.

In addition, the system of the present invention comprises a response analytics feature or option in which the system is structured to analyze and calculate various response data associated with a particular advertisement, advertisement campaign or other promotional media 34. The resultant data may be used by the advertiser and/or the system itself to provide feedback and data associated with the effectiveness of the advertisement and methods of delivering the advertisements to the users.

Furthermore, and in contrast to previously known mobile-based applications which require a user to “check-in” to the location, such as by virtue of scrolling through a list of nearby locations, selecting the appropriate location, and actively checking into the location, at least one embodiment of the present invention is structured to automatically communicate the promotional media 34 to the user device 100 when the user device 100 connects to a nearby WLAN, or is otherwise disposed within a user-selected promotional range of the establishment 40. More in particular, the social networking application 200 of at least one embodiment of the present invention does not require the user to actively “check in” to the establishment 40, or for the user to post any location data on other global social networking sites (e.g. Facebook, Twitter, etc.) in order to receive promotional or informational media. Instead, the present invention is structured to automatically communicate promotional media 34 to the user device 100 and/or application 200 upon connection to a particular communication network 20, a nearby communication network, or being within a selected promotional range, as will be described below.

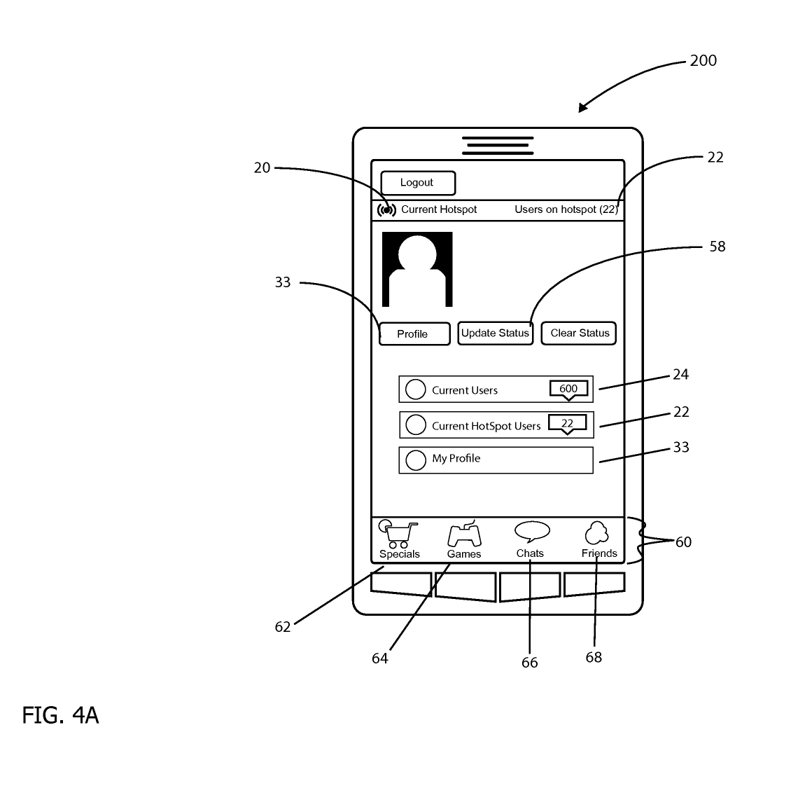

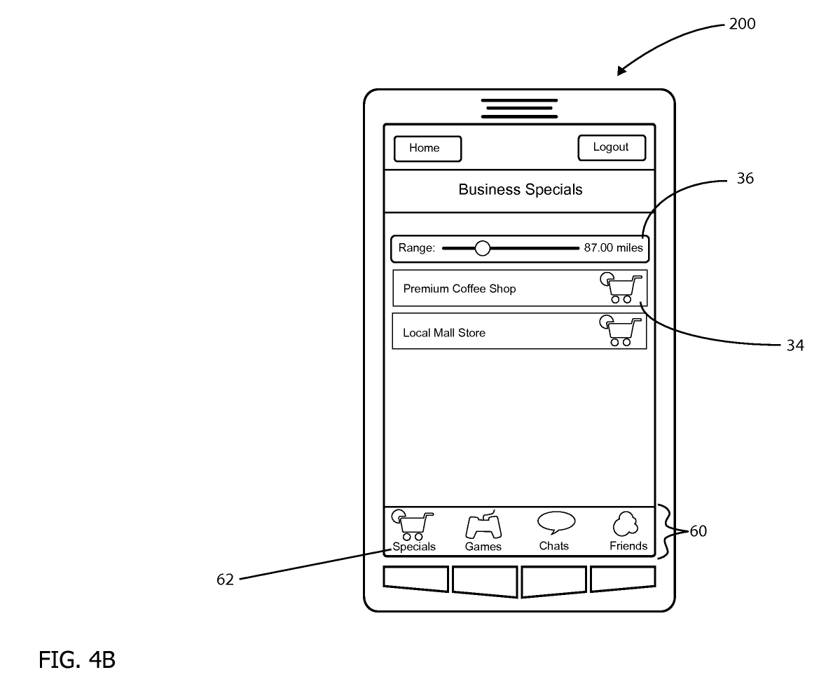

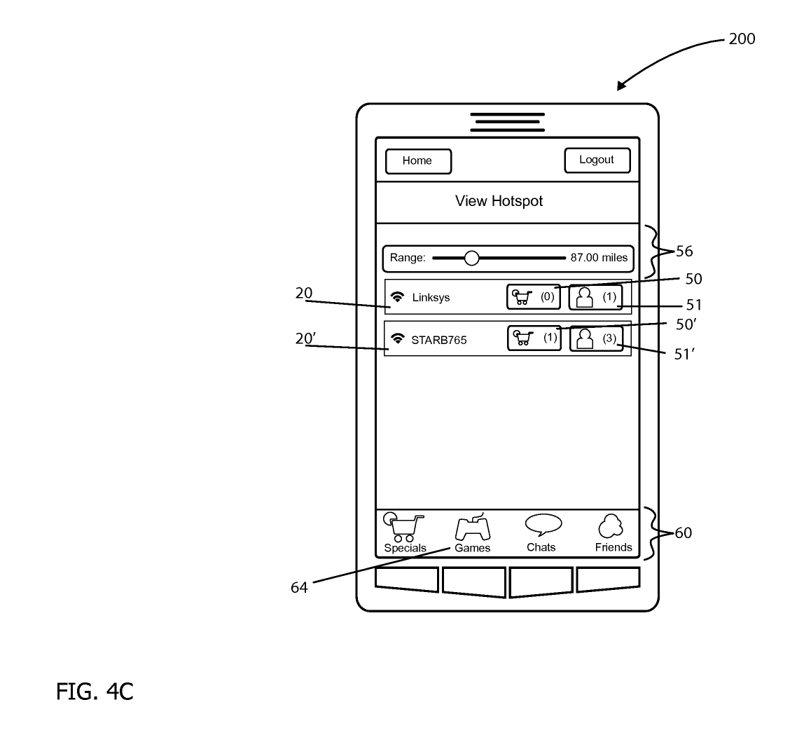

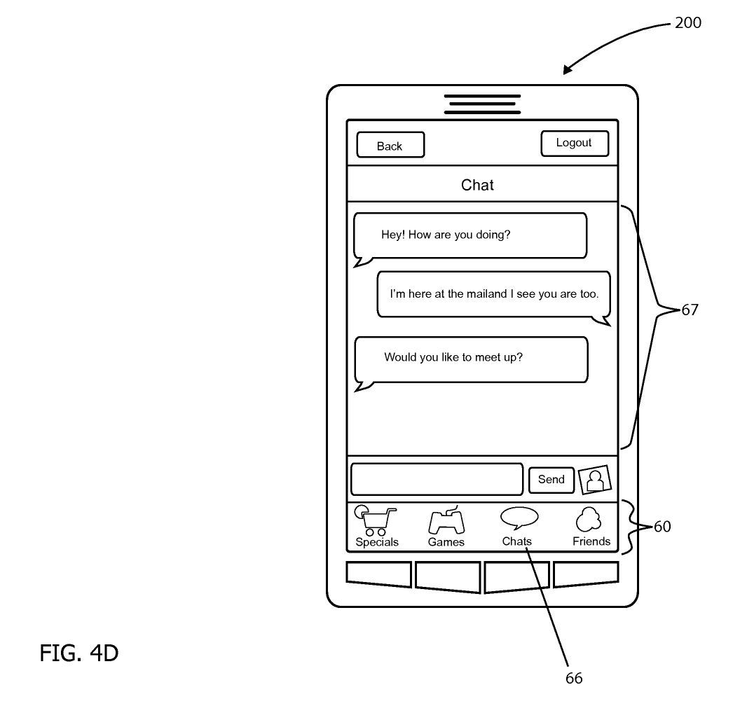

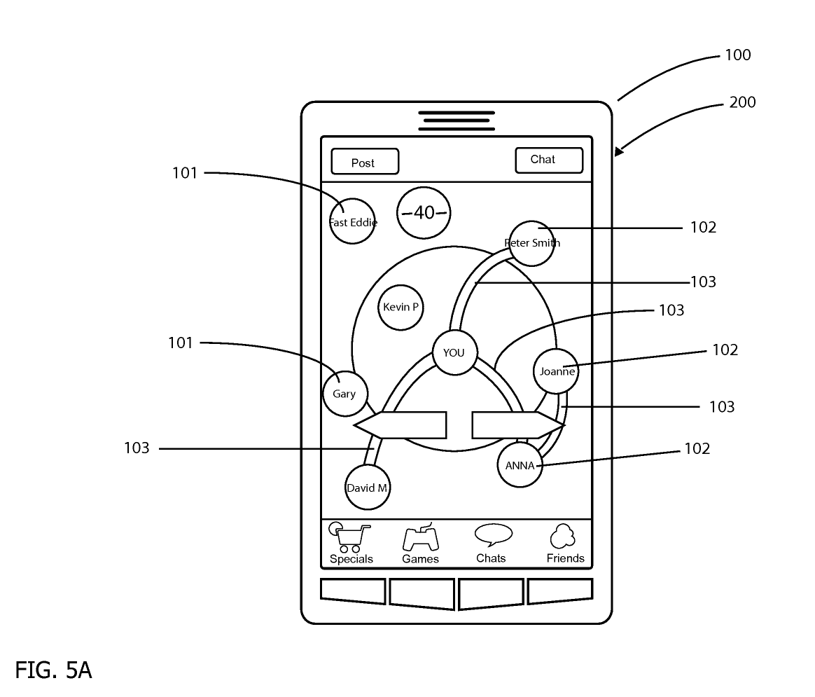

For instance, as illustrated in the exemplary screenshot of FIG. 4B, the social networking application 200 of at least one embodiment comprises a graphically-presented user-selectable promotional range module 36 which is structured to define a user-selected promotional range. Accordingly, when the user device 100 is otherwise disposed in a communicative relation with a WIFI hotspot, WLAN, or other communication network 20 and a commercial establishment 40 is located within the user-selected promotional range, the user device 100 and/or the social networking application 200 thereof, is capable of automatically receiving promotional media 34 from the commercial establishment 40. If the user device 100 moves out of range or if the user reduces the user-selected promotional range (e.g., by sliding the scale or module 36) such that the commercial establishment 40 is thereby located out of or beyond the user-selected promotional range, the application 200 of the present invention is structured to automatically and in real time remove the corresponding promotional media 34 from the display.

In particular, the commercial establishment 40 need not be located within range of the WIFI hotspot, WLAN or communication network 20 to which the user device 100 is directly connected in order to communicate promotional media 34 thereto. Instead, in at least one embodiment, the commercial establishment 40 may be located beyond the direct range of the communication network 20 but within the user-selected promotional range in order to communicate promotional media 34 to the user device. For example, referring to FIG. 2, commercial establishment 40 may communicate promotional media 34 to user devices 100 which are connected to or otherwise located within range of a common WIFI hotspot. In addition, however, and assuming the commercial establishment 40 is within a user-selected promotional range of user devices 100′, user devices 100′ may still automatically receive promotional media 34 from commercial establishment 40 even though user devices 100′ are connected to a different WIFI hotspot 20′ than commercial establishment 40 or otherwise outside of range of the WIFI hotspot associated with commercial establishment 40.

In particular, the received promotional media 34 can include information such as, for example, menu items, available products, and promotions. As another example, the social networking application 200 can connect to the social networking management system 30 and/or other servers 32 and/or other commercial communication device(s) in order to receive recommendations from host commercial establishments 40 regarding recommended combinations of items (e.g., food and wine pairings, book recommendations, etc.).

Referring again to FIG. 1, the diagram presented therein illustrates how the application can, in at least one embodiment, use a free public WLAN to identify where other user devices 100 are located and where commercial establishments 40 are located, and to enable users and hosting establishments 40 to communicate with the each other via the free public WLAN. In some embodiments, users can also connect to the Internet to increase the amount of information available to the application. In some embodiments, the application can also connect to the server(s) 32 of the host commercial establishment 40 to provide additional information to the user. In some embodiments, the application can allow a user to connect to host establishment's server 32 through a secure connection to perform transactions (e.g., using a credit card). In this manner, a user may, for example, pay for or reserve a particular product of the host commercial establishment.

For exemplary purposes only, the social networking application 200 of the various embodiments of the present invention can be used to provide location-specific assistance to a user in a large space such as in an arena, stadium, hotel, playhouse, theater, or other venue of this type. As another example, the application 200 can provide a user with suggestions for social networking opportunities based on location and similarities in the users' preferences. In addition, the social networking application 200 may, in at least one embodiment, allow a user to search for and locate local events, gatherings, concerts, marches, presentations, etc. While at the local event, the user is able to communicate with other nearby users at the same event and/or with nearby establishment by virtue of using the social networking application described in accordance with the present invention.

In addition, through the social networking application 200 of at least one embodiment of the present invention, the host commercial establishment 40 can provide unique shopping, dining and entertainment experiences. In addition, the application 200 may be structured to create a tailored and personal experience (e.g., by promoting continuity and maintaining contact between a commercial establishment 40 and a user based on the user's profile and/or personal preferences and habits). The application 200 may also enhance a user's experience through monetization, for example, up-selling and cross-selling offers may be presented to a user through the application. The application 200 of at least one embodiment may also allow for enhanced customer relationships with both new and existing customers, for example, by building customer relations and promoting customer retention.

In particular, since a portable electronic device's simplicity, affordability, and portability may appeal to a broad scope of users, a broad scope of users may be using the application 200 described herein, and through the application 200, be introduced to host commercial establishments 40. Host commercial establishments 40 may then be given the opportunity to reach this wide range of shoppers through the application 200. In this manner, a single application 200 can control and enhance the user's experience as well as increase the extent and quality of exposure of host commercial establishments 40. An additional advantage includes the social networking aspect which enhances the user's shopping, entertainment or other experiences and can also increase the personalization, monetization, and relationship building advantages available to the commercial establishments 40. For example, a user can send or receive instant recommendations to users in close proximity, providing opportunities to up-sell or even create new customer relationships.

Referring again to FIGS. 1 and 2, at least one embodiment of the present invention comprises a remote social networking management system 30 disposed in a communicative relation with a wide-range or global communication network 12. In particular, the wide-range or global communication network 12 as used herein includes, but is in no way limited to, a plurality of interconnected computer networks utilizing the Internet Protocol (TCP/IP) or other like protocols, the World Wide Web, etc. More in particular, the remote social networking management system 30 of at least one embodiment is disposed in a communicative relation with the various mobile user devices 100 by virtue of the local communication network 20, 20′ being connected to the global communication network 12, as generally illustrated in FIG. 2. In this regard, the remote social networking management system 30 comprises at least one computer processor and a storage device and is otherwise structured to facilitate the practice of the present invention in the intended manner. The remote social networking management system 30 may thus comprise virtually any computer or computer system, including an Internet or web server, desktop, laptop, notebook or tablet computer, mobile computer, handheld or portable computer, etc.

The remote social networking management system 30 further comprises a plurality of social media stored thereon, which is communicated to or exchanged with a corresponding mobile user device or interface 100. In particular, the social media of at least one embodiment comprises a plurality of user profile data or information, including, but certainly not limited to, user name, password, preferences, hobbies, etc. The social media may further comprise a list or identification of user “friends” which the corresponding user previously added as a friend, acquaintance, or connection. In this manner, each time a user connects to a WIFI hotspot, WLAN or other local communication network 20, 20′, the remote social networking management system 30 is capable of authenticating the user (e.g., via a username, password, or other identification information or data). Once the user or mobile device 100 is connected or authenticated by the remote social networking management system 30, the remote social networking management system 30 may notify the user or user device 100 if any friends or prior contacts are in the vicinity or otherwise located with a user-selected communication range.

In at least one embodiment, however, it is contemplated that various social media, including user profile data, friend lists, etc. are stored on the user device 100 itself and therefore connection to a remote social networking management system 30 may not necessarily be required for the system and method of the present invention to operate in the intended manner.

In any event, the social networking application 200 of the present invention is structured to connect or otherwise allow two or more user devices 100, 100′ to communicate with one another via mobile to mobile or application to application chat, video chat, voice chat, and/or communication of data, including photographs, audio files, video files, sound clips, ringtones, etc. For example, in at least one embodiment of the present invention, a first user device 100 may communicate with, be disposed in a communicative relation with, or otherwise identify the presence of a second user device 100, 100′ via the social networking application 200 so long as the second user device is disposed within a user-selected communication range of the first user device 100. In a preferred embodiment, the user-selected communication range is set or selected by at least one of the user devices 100, 100′ (e.g., the user device 100 initiating the communication or contact), however, it is contemplated that in order for two user devices 100, 100′ to communicate with or identify the presence of one another, both of the devices must be in range of the user-selected communication range set on both devices 100, 100′. More in particular, the social networking application of at least one embodiment is structured to create an ad-hoc network on one or more WIFI hotspots, local communication networks, etc. in order to connect the corresponding mobile devices 100 in a communicative relation with one another for direct peer-to-peer communication. Although, as described herein, at least one embodiment comprises a social network management system 30, the ad-hoc network or communication channel between two or more mobile devices 100 or applications of the present invention may be implemented without the need for or connection to a remote server or other like device.

Furthermore, as illustrated in the embodiment shown FIG. 2, the user devices 100, 100′ may be, but need not be, connected to a common WIFI hotspot, WLAN or local communication network 20, 20′ in order to communicate with one another via the social networking application of the present invention. Specifically, mobile user devices 100 and 100′ (connected to different networks 20 and 20′, respectively) may communicate with one another in the same manner that user devices 100 (connected to a common network 20) may communicate with one another.

In particular, as generally illustrated in FIG. 4C, the social networking application 200 of at least one embodiment comprises a graphically-presented user-selected slidable communication scale or module 56 which is operatively structured to define a user-selected communication range. Of course, the scale 56 need not be slidable and may instead comprise any selection apparatus, including a plurality of buttons, or a user-input where a user can identify a specific or preferred range. Accordingly, as the user slides or otherwise selects various values or distances on the scale 56, the social networking application 200 is structured to update, in real time, the display of various WIFI hotspots or networks 20, 20′ located within the selected range. In particular, the communication range defined by the scale 56 of at least one embodiment comprises a radial distance measured outward from the current location of the device 100. The radial distance of a preferred embodiment is measured by miles and may extend as far as 200 or more miles. Of course, it is within the scope and intent of the present invention that other measurements and denominations may be similarly implemented.

For exemplary purposes only, the range selected in FIG. 4C is 87.00 miles and the social networking application 200 identified and displayed two networks 20, namely, “Linksys” and “STARB765” networks. Furthermore, and still referring to FIG. 4C, the social networking application 200 of at least one embodiment is structured to identify and display the total number of business specials 50, 50′ available to the correspondingly identified network 20, 20′ respectively. For instance, a business special 50, 50′ may be affiliated with a corresponding commercial establishment 40 disposed in a communicative relation with the corresponding network 20, 20′. In addition, the social networking application 200 is structured to identify and display the total number of users, friends and/or connections 51, 51′ connected to the correspondingly identified network 20, 20′. A “friend” or “connection” comprises a previously added, identified or linked account or user that is currently connected to the network 20, 20′.

The user may select a particular network 20, 20′ at which time the social networking application 200 is structured to display a list of users connected to the selected network 20, 20′ At least one embodiment is structured to identify which users on that list are “fiends”, for instance, via a star, friend icon, highlighted or unique text, etc. In any event, the user may click or otherwise select one or more of the users in the list to initiate a chat, as exemplified in FIG. 4D. Upon doing so, the social networking application 200 is structured to open a communication window 67 which allows the two or more users to communicate (via text chat, voice chat, video chat, etc.) As illustrated in the example shown in FIG. 4D, the communication window 67 comprises a selectable “add friend” field or button which a user can select. Upon doing so, the social networking application 200 will link the two profiles associated with the corresponding users for subsequent identification as “friends.” The social media at the remote social networking management system 30 is updated accordingly. This feature allows users to easily meet other nearby users (who may share common interests, preferences, etc.) and easily add the user as a friend during a chat session.

Referring now to FIG. 4A, the social networking application 200 comprises a menu bar 60 displaying a number of selectable menu or navigation items 62, 64, 66, 68. Furthermore, a user may set a “status,” as generally represented at 58, in which other users of the application 200 may view. In addition, the social networking application is structured to identify and graphically display a number of common network users (represented as 22 in FIG. 4A). Specifically, a common network user 24 as used herein includes other users or mobile user devices 100 executing or accessing the social network application 200 and being connected to a common WIFI hotspot or network 20. In addition, the social networking application 200 of at least one embodiment is structured to identify and graphically display a number of in-range users (represented as 24 in FIG. 4A). Specifically, an in-range user comprises a user or user device 100 executing or accessing the social networking application 200 and being disposed within the user-selected communication range, as described herein. Therefore, an in-range user may or may not be connected to a common network 20.

Accordingly, referring to the exemplary embodiment of FIG. 4A, the user is connected to a network 20 identified as “Current Hotspot”. The social networking application 200 has identified and is displaying twenty two (22) common network users 22, who are also connected to the same network, namely, Current Hotspot. The six hundred (600) in-range users identified at 24 may be connected to Current Hotspot or another network nearby, or within range of the user-selected communication range.

Referring now to FIG. 4B, if a user selects “Specials” 62 on the menu bar 60 (or otherwise directs the social networking application 200 to a business specials or promotion section), the user is able to select a range in which to view nearby commercial establishment promotions, advertisements, menus, coupons, etc (as generally referenced at 34). For instance, as identified above, the social networking application 200 comprises a scale 36 in which a user can define a user-selected promotion range. Any businesses or commercial enterprise in the selected range can communicate promotions or other information to the user device 100 without the user having to “check-in.” Of course, in at least one embodiment, the social networking application 200 may display the promotions 34 in any manner, including on a permanently visible banner or bar, via push notification, text message, email, etc.

Referring now to FIG. 5A, the social networking application 200 of yet another embodiment comprises a graphical location-based display illustrating other users 101,102 and their relative distance away from the viewer. For instance, in the exemplary embodiment illustrated, user identified as “KevinP” is closer than user identified as “Peter Smith.” In addition, the social networking application 200 may further comprise graphically displayed links 103 structured to identify a “connection” with the linked user 102. For instance, a “connection” as used herein may include another user 102 that a user has spoken to previously, or another user 102 that shares interests, preferences, hobbies, etc., as identified in the user's profile. For instance, the social networking application 200 or the remote social networking management system 30 of at least one embodiment is structured to analyze the user profiles and “link” users together that share common interests, etc.

Accordingly, the view illustrated in FIG. 5A is a schematic view of the location-based functions and graphical interface available for the user for browsing connected users or commercial establishments in the vicinity. For example, the functions of diagram can be used to initially and visually educate a user about the available commercial establishments in proximity, and the existence of other users in proximity. As identified above, the user can indicate to the device or system what distances to search (via the user-selected communication range and user-selected promotional range), and link to the Internet if necessary to access additional information. For example, the social networking application 200 can access an integrated or accessible mapping application to provide a map, direction, or both to a host commercial establishment 40.

FIG. 5C comprises a schematic illustration of how the user can then select another user 102, or all users, and communicate with them via chat, video chat, voice chat, or audio-visually. The users can also send each other data through the application 200. For example, the schematic illustration presented in FIG. 5C further shows how a location-based invitation from an unknown user to chat might be indicated to a user. The user can ignore the bubble and it will disappear, or the user can tap the bubble to chat with the other user.

FIG. 5D shows a schematic illustration demonstrating how such a chat might appear on the screen should the receiving user choose to accept the invitation to chat. The user can swipe up or down to view the conversation and multiple users can also chat at once. Multiple-user chat is also contemplated within the scope of the present invention.

FIG. 5E illustrates how data sent from one user to another user may appear in the user display. The recipient can delete the received data, or tap it to make it larger if it is a still visual, or to make the data play if it the data comprises a video or audio file, etc.

FIG. 5F illustrates how a host commercial establishment 40 of at least one embodiment can then attract a user with promotions, invitations to special events, etc. As identified above, the promotions can include, for example, coupons for on-sale items, time-sensitive sale information (e.g., a sale such as “buy this item within the next two hours to receive 25% off!” to entice buyers to come to stores to take advantage of the limited offers), or any other suitable promotions. The invitations can include general events for a specific subset of customers (e.g., a “friends and family” event), a personalized event for the user himself, alerts of particular items or services (e.g., a new collection that has arrived, items now on sale, and the like), or any other suitable item. For example, in one embodiment, a time-sensitive and user-only sale can be provided.

The promotions and invitations can be provided to the user in any suitable manner. For example, the promotions and invitations can include an e-mail, a text message, a pop-up message, a push notification, any other suitable notification, or any combination of the above. In some embodiments, a user can specify user preferences to determine what promotions and invitations are received by the integrated application. For example, user preferences can determine that a user desires to receive promotions and invitation associated with a certain commercial establishment, a certain item or service, a certain location, or any other suitable preference. In this manner, a host commercial establishment 40 can easily and conveniently contact customers and potential customers who are in close proximity to the establishment and benefiting from the host establishment's free public WLAN by transmitting promotions and invitations directly to the electronic devices of persons who may be easily attracted because of the proximity of the hosting commercial establishment.

In some embodiments, a user can pre-order or reserve items of interest. For example, a user may reserve a table at a restaurant, or reserve an item for which it received a promotion. The user may then come to the host commercial establishment's store to view the reserved item in-person. Furthermore, since the user may potentially buy additional merchandise from the host commercial establishment 40 once they are in-store, allowing the user to reserve items can result in generating additional revenue for the commercial establishment. In some embodiments, a user can provide payment or credit card information (e.g., through a secure network of the host commercial establishment) to secure the desired item or reservation.

Returning to FIGS. 5D and 5E, the application 200 of at least one embodiment can provide a user with social networking features to request and receive feedback from friends and other users. The user may send photographs, video, or chat about a product and other users can send back recommendations. This may also provide additional revenue for the host commercial establishment 40 by way of work of mouth. For example, at a restaurant a user may taste a meal and take a photograph of it, and send it to all users in proximity with a message indicating how tasty it is, thereby enticing other users to eat at the same restaurant.

Users can also rate and review commercial establishments after visiting or purchasing from a commercial establishment. In some embodiments, the integrated application can provide an opportunity directly to a user's electronic device for leaving ratings. In this way, later users will have additional information on the commercial establishment.

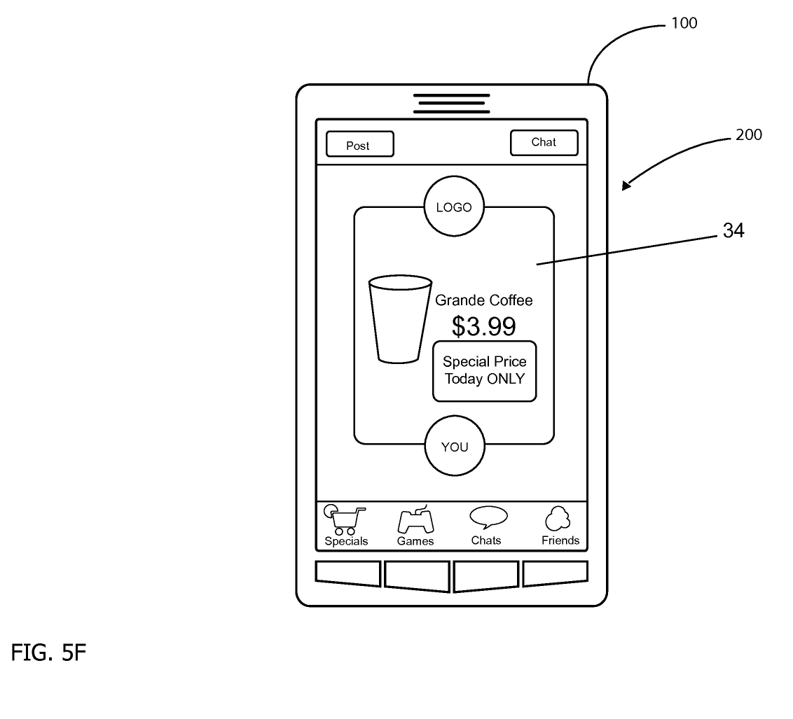

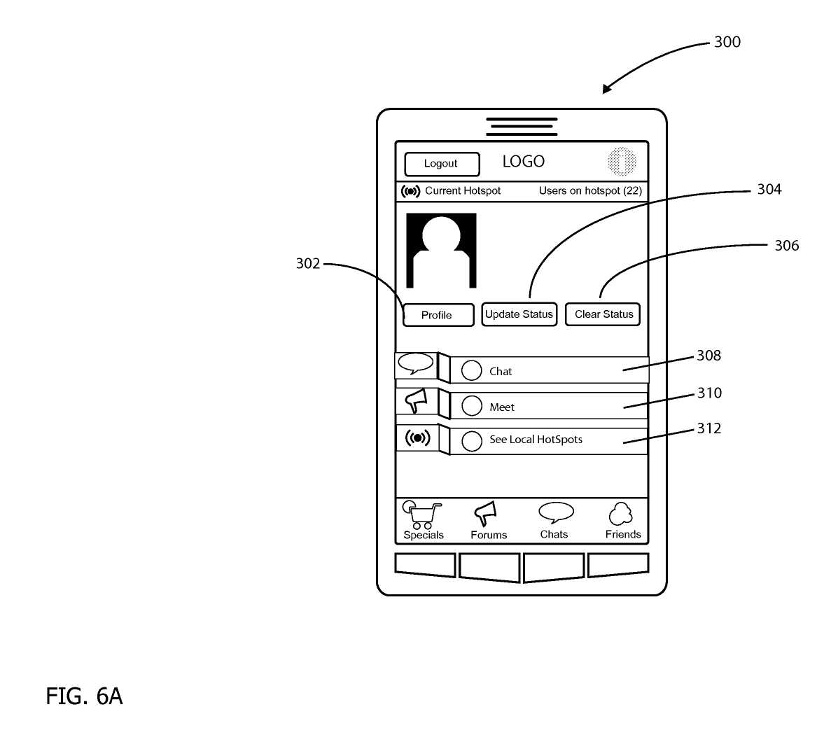

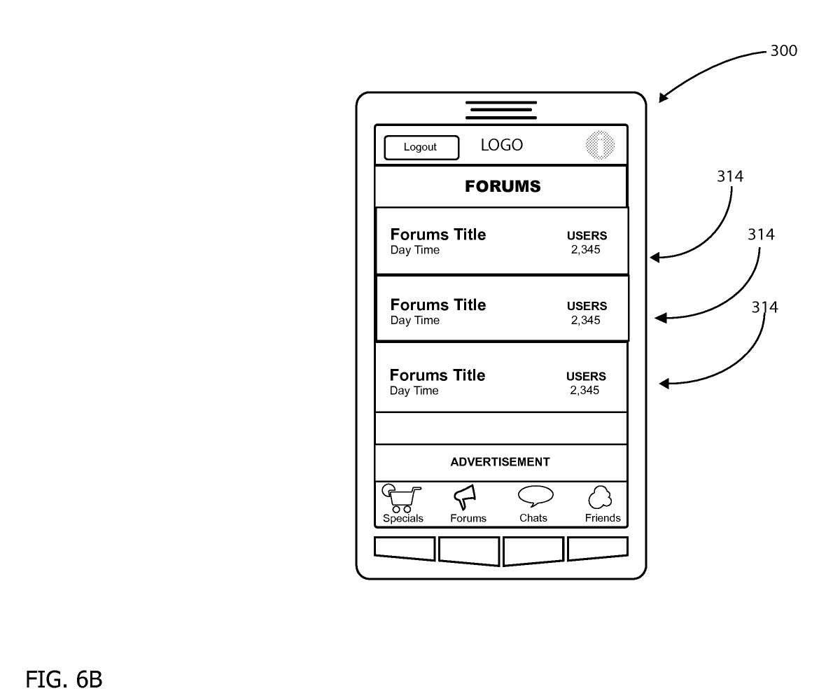

Referring now to FIGS. 6A and 6B, yet another embodiment of the present invention further comprises one or more social group applications, generally represented as 300. Similar to the social networking application 200 described in detail above, the social group application 300 is structured to be executed, run or otherwise accessed by a mobile user device 100. In particular, however, the social group application 300 of at least one embodiment is specifically tailored, structured, designed, branded, marked, or programmed for a particular organization, demographic, group or party, which may be indicated via a logo as exemplified in FIGS. 6A and 6B. For instance, a member of the corresponding group or a user interested in the corresponding group associated with a particular social group application 300 may download, execute, run and/or otherwise access the social group application 300.

In at least one embodiment, the social group application 300 is structured to communicate with, identify, or otherwise interact with other social group applications 300 associated with a common social group or organization. Referring to the example shown in the Figures, a user of the social group application 300 associated with the group may, in at least one embodiment, only communicate with, identify, locate, or interact with other users of the social group application. It is contemplated, however, that in yet another embodiment, the social group application 300 associated with a first group or organization may interact or communicate with a social group application associated with a second or different group. Additional features including, but not limited to the selectable communication range, selectable promotional range, receipt and display of promotional media, ad hoc communication channels, etc., as described in greater detail above are also implemented in the social group application 300 described herein.

For exemplary purposes only, a user of the social group application 300 may access and change the user's profile by selecting button 302, update the user's status that may be displayed to other users by selecting button 304, and/or clear the user's previously entered status by selecting button 306. The user may also select or identify whether he or she is available to chat with other users (as generally illustrated at 308) and/or whether he or she is available to meet other users (as generally illustrated at 310). Depending on the user's selection, the application 200, 300 is structured to identify the user's availability to other user's or other applications 200, 300 in the network. Furthermore, as generally illustrated at 312 in FIG. 6A, the user may select “See Local Hotspots” or other similar selectable button, item or module in order to view a list of local networks 20, such as nearby WIFI hotspots, WLANs, etc. Upon doing so, the user may select a communication and/or promotional range as described in detail above.

A further feature of at least one embodiment of the present invention, shown in FIG. 6B, includes a list of various forums 314 in which a user can read, post comments, post articles, thoughts, pictures, video, or other media. In particular, and referring to the social group application 300 of FIG. 6B, the forums may be dedicated to the corresponding group or organization associated with the particular social group application 300. For instance, if the associated group is a political party, the various forums listed may be associated with the political party's movement, posted by party members or supporters, posted using the corresponding social group application, etc. Such a feature allows the members of a common group to easily obtain news, information, media, etc associated with the group or organization, and may be particularly useful during a specific event such as a march, gathering, political election, party, dinner, etc.

Furthermore, the social group application 300 of the present invention facilitates direct marketing to users of a particular organization, group or demographic by communicating specifically tailored or selected advertisements to selected groups or selected social group applications 300.

In at least one embodiment, location-based gaming is also within the scope of the present invention. For example, using the social networking application 200,300 of the present invention, a plurality of users disposed in a common or proximate location (e.g., connected to a common hotspot, disposed within a communication range or selected gaming range, etc.) are capable of playing one or more games with or against one another. The users are able to chat and communicate with one another via the mobile application. Specifically, the users are able to essentially convert or utilize an existing hotspot or a plurality of proximate hotspots into a customized gaming community.

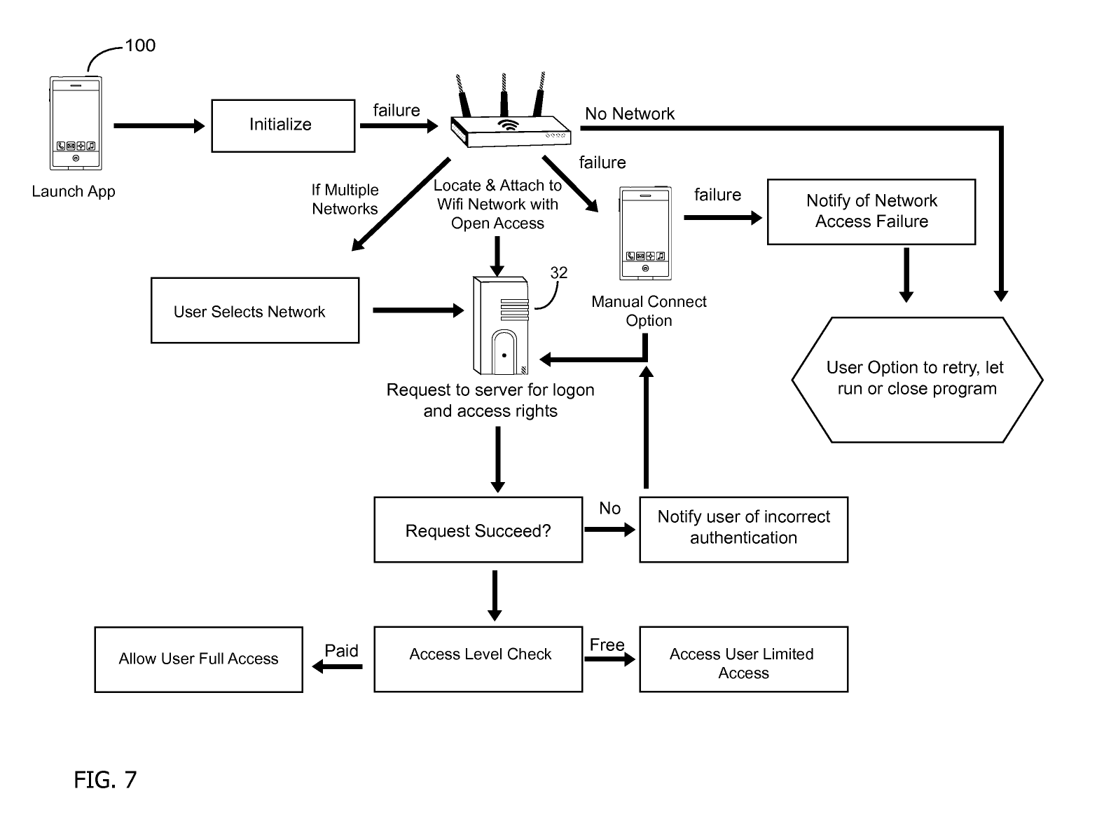

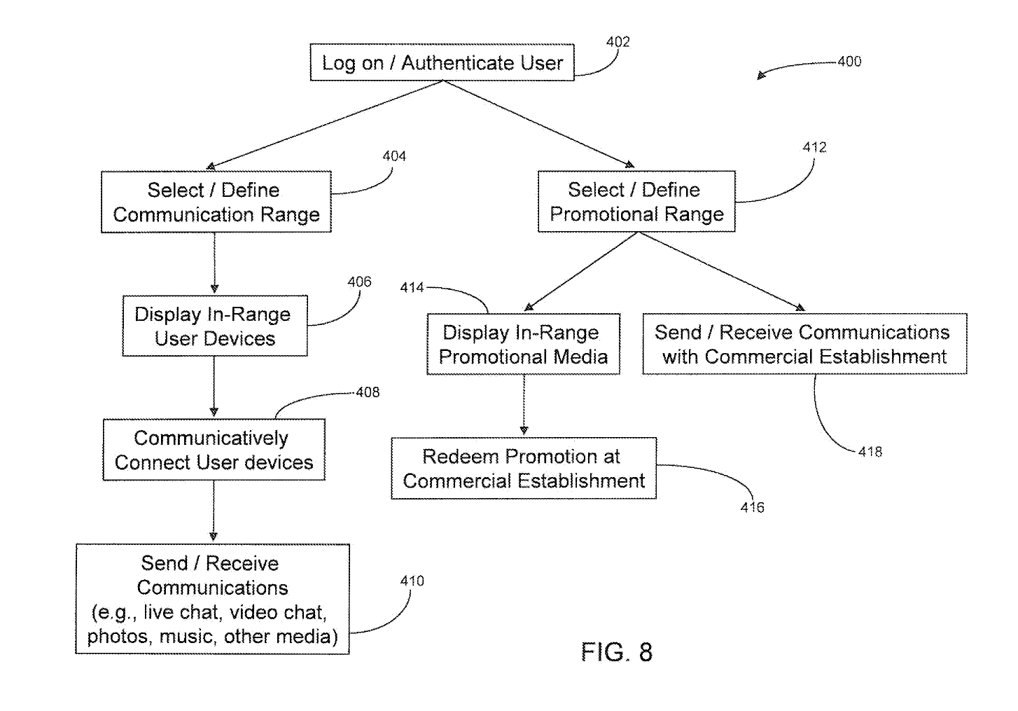

The present invention and disclosure further comprises a method 400 for interactive communication on a local social network platform utilizing the system 10 and components described in detail above, including, the mobile user devices 100, social networking application(s) 200,300 the remote social networking management system 30 and the establishment server(s) 32. The method 400 of the present invention comprises the manner in which the social networking application 200 connects to the local network(s) 20 and how the remote social networking management system 30 authenticates a user, as illustrated at 402 in FIG. 8 and as generally presented in the high level flow chart of FIG. 7. In addition, however, the method 400 of the present invention further comprises various steps on communication of promotional media to the user device 100 as well as communication between various user devices 100 as described in detail above.

In particular, the method 400 of at least one embodiment comprises selecting and/or defining a communication range, as generally represented at 404. Specifically, the communication range may be defined or selected in a number of different manners, including, for example, via a communication range selection module, as described in greater detail above. The communication range selection module may comprise a slidable selection scale, input box, selectable buttons, inputs, etc. which when activated or selected by a user will define the user-selected communication range. Of course, the communication range may be pre-defined or set by the application itself and thus may in at least one embodiment need not be selected or defined by the user.

Either way, the method 400 further comprises displaying an identification of a plurality of other user devices disposed within the communication range. Such devices, whether disposed in a communicative relation with a common hotspot or a different non-overlapping hotspot, are referred to as in-range user devices. Moreover, the display of user devices may be graphical, such as via a map or a relational view as compared to the user device 100. In particular, in at least one embodiment, the display of in-range user devices is structured to present a graphical interface representing the relational distance and direction of the user relative to the mobile user device 100. As described above, the graphical display may further include graphically displayed links 103 between “friends” or connected users. Other embodiments may present the identification of in-range user device via a list or non-list presentation.

Moreover, as schematically represented in FIG. 2, at least one of the in-range user devices comprises an outside, in-range user device 100′ defined as a user device disposed in a communicative relation with a different network or hotspot 20′ than the original or central hotspot 20 in which the mobile user device 100 is connected. Accordingly, as long as the two user devices 100, 100′ are disposed within the communication range of one another, it does not matter if they are connected to a common hot spot or different non-overlapping hotspots, as the present invention is structured to, or otherwise capable of, disposing the devices 100, 100′ in a communicative relation with one another, as generally presented at 408 and 410 in FIG. 8.

Furthermore, and still referring to FIG. 8, the method 400 of at least one embodiment comprises selecting or defining a promotional range, as generally represented at 412. Specifically, and similar to the communication range presented above, the promotional range may be defined or selected in a number of different manners, including, for example, via a promotional range selection module. In particular, the promotional range selection module may comprise a slidable selection scale, input box, selectable buttons, inputs, etc. which when activated or selected by a user will define the user-selected promotional range. Of course, the promotional range may be pre-defined or set by the application itself and thus may in at least one embodiment need not be selected or defined by the user.

Nevertheless, as illustrated at 414, in at least one embodiment, the present invention is structured to display or present in-range promotional media to the mobile user device 100 and/or to the user thereof. In particular, the in-range promotional media comprises promotional media (e.g., coupons, sales, advertisements, etc.) from or associated with one or more commercial establishments disposed within the promotional range of the mobile user device 100. Accordingly, in at least one embodiment, the user may define the range in which he or she desires to receive promotional media 34. If the user changes the promotional range, the displayed promotional media is automatically updated in real-time, and thus the user can, in at least one embodiment, slide the promotional scale back and forth to immediately and automatically reveal and hide promotional media. Once the user has the promotional media, or otherwise, once the promotional media is displayed on the user's mobile device, the user may redeem the promotion, coupon, deal, etc. at the commercial establishment, as generally illustrated at 416. This can be accomplished in a number of different ways, including showing the commercial establishment or agent the promotional media displayed on the screen, communicating a promotional code or password to the establishment, etc.

Additionally, and still referring to FIG. 8, in at least one embodiment, the user may communicate directly with the commercial establishment disposed within the promotional range, as shown at 418. Although, such communications between the user and the establishment may frequently ask for assistance on an item, order food, reserve a table, identify an open or ready table, etc., any communications are within the scope of the present invention.

The process discussed above is thus intended to be illustrative and not limiting. Those skilled in the art could appreciate that steps of the process discussed herein can be omitted, modified, combined, or rearranged, and any additional steps can be performed without departing from the scope of the invention.

The invention presented herein can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer-readable medium can also be distributed over network coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for mobile interactive communication on a local social networking platform, comprising:
a remote social networking management system disposed in a communicative relation with a wide-range communication network and communicable with a plurality of mobile user interfaces, each of said plurality of mobile user interfaces comprising a computer processor and a memory and further disposed in a communicative relation with at least one local network,
a plurality of social networking media stored on said remote social networking management system, said social networking media comprising a plurality of user profiles, wherein said remote social networking management system comprises a computer processor and a storage device, and
a social networking application separately executable by each of said plurality of mobile user interfaces,
wherein said social networking application executed by at least one of said mobile user devices is structured to automatically receive and display promotional media associated with a commercial establishment, said commercial establishment being located within a user-selected promotional range.

2. The system as recited in claim 1 wherein said social networking application is structured to receive said promotional media from at least one commercial server associated with the commercial establishment.

3. The system as recited in claim 1 wherein said social networking application comprises a graphically presented slidable promotional scale structured to define said user-selected promotional range.

4. The system as recited in claim 3 wherein the commercial establishment is located within range of said local network and within said user-selected promotional range.

5. The system as recited in claim 3 wherein the commercial establishment is located within said user-selected promotional range but beyond range of said local network.

6. The system as recited in claim 3 wherein upon selection of a different promotional range, said social networking application is structured to immediately and automatically update said promotional media displayed on said mobile user interface corresponding to said different promotional range.

7. The system as recited in claim 1 wherein said promotional media communicated to and displayed on said mobile user interface is tailored to a user profile associated with said mobile user interface.

8. The system as recited in claim 1 wherein said social networking application is structured to communicate in real-time, via said local network, with a commercial communication device associated with the commercial establishment.

9. The system as recited in claim 1 wherein said social networking application executed by a first mobile user interface is structured to communicate with said social networking application executed by a second mobile user interface, wherein said second mobile user interface is located within a user-selected communication range of said first mobile user interface.

10. The system as recited in claim 9 wherein said first mobile user interface and said second mobile user interface are disposed in a communicative relation with a common WIFI hotspot.

11. The system as recited in claim 10 wherein said social networking applications executed by said first and said second mobile user interfaces are structured to create an ad-hoc application-to-application communication channel.

12. The system as recited in claim 9 wherein said first mobile user interface and said second mobile user interface are disposed in a communicative relation with different non-overlapping WIFI hotspots.

13. The system as recited in claim 9 wherein said social networking application comprises a slidable communication scale structured to define said user-selected communication range.

14. The system as recited in claim 9 wherein said user-selected communication range includes a radial distance of at least two hundred miles from the location of said first mobile user interface.

15. A system for mobile interactive communication comprising:
a social networking application separately executable by each of a plurality of mobile user devices disposed in a communicative relation with at least one WIFI hotspot, the mobile user devices each comprising a computer processor and a memory,
said social networking application structured to identify and graphically display a number of common WIFI users, wherein said common WIFI users comprise at least one of the mobile user devices executing said social networking application and being connected to a common WIFI hotspot,
said social networking application further structured to identify and graphically display a number of in-range users, wherein said in-range users comprise at least one of the mobile user devices executing said social networking application and being located within said user-selected communication range, and
wherein said social networking application executed by a first mobile user device is structured to communicate with said social networking application executed by a second mobile user device via an ad-hoc communication channel.

16. The system as recited in claim 15 wherein said social networking application comprises a communication window structured to allow communication between at least two of said plurality of mobile user devices; said communication window comprising a selectable add friend field for linking user profiles as friends for subsequent identification

17. The system as recited in claim 15 wherein said social networking application comprises a slidable communication scale structured to define said user-selected communication range.

18. The system as recited in claim 15 wherein said social networking application is structured to automatically receive and display promotional media associated with a commercial establishment located within a user-selected promotional range.

19. The system as recited in claim 18 wherein said social networking application is structured to receive said promotional media from at least one commercial server associated with the commercial establishment.

20. The system as recited in claim 18 wherein said social networking application comprises a slidable promotional scale structured to define said user-selected promotional range.

21. The system as recited in claim 15 further comprising a remote social networking management system disposed in a communicative relation with a global communication network and communicable with said plurality of mobile user devices.

22. The system as recited in claim 21 further comprising a plurality of social network media stored on said remote social networking management system, said social networking media comprising a said user profiles.

23. A method for mobile interactive communication, comprising:
presenting a communication range selection module on a mobile user device via a social networking application displayed thereon, the mobile user device comprising a computer processor and a storage device and further being disposed in a communicative relation with a local communication network,
defining a user-selected communication range via the communication range selection module,
displaying on the mobile user device via the social networking application an identification of a plurality of other user devices disposed within the user-selected communication range, wherein at least one of the other user devices comprises an outside, in-range user device disposed in a communicative relation with a different local communication network beyond range of the local communication network in which the mobile user device is communicatively connected, and
disposing the mobile user device in a communicative relation with the outside, in-range user device.

24. The method as recited in claim 23 further comprising defining the local communication network as including a WIFI hotspot.

25. The method as recited in claim 24 further comprising defining the different local communication network as including a WIFI hotspot.

26. The method as recited in claim 23 further comprising presenting a promotional range selection module on the mobile user device via the social networking application displayed thereon, and defining a user-selected promotional range via the promotional range selection module.

27. The method as recited in claim 26 further comprising communicating promotional media to the mobile user device, the promotional media being associated with a commercial establishment disposed within the user-selected promotional range.
